(19) United States
(12) Patent Application Publication
(10) Pub. No.: US 2006/0147860 A1
(43) Pub. Date: Jul. 6, 2006

(54) Gas stove

(75) Inventor: Sen-Yu Wu, Taichung Hsien (TW)

Correspondence Address: BRUCE H. TROXELL;SUITE 1404, 5205 LEESBURG PIKE, FALLS CHURCH, VA, 22041, US

(73) Assignee: Seven Universe Industrial Co., Ltd.

(21) Appl. No.: 11/028,570

(22) Filed: Jan. 5, 2005

(51) Int. Cl. F23Q 9/00; F24C 3/00; A47J 37/00

(52) U.S. Cl. 431/278; 431/258; 126/41 R

(57) ABSTRACT

A gas stove has a lower stove having a first stove member, a plurality of gas ignition devices at a side of the first stove member and a gas burner at a top side of the first stove member and connected to one of the gas ignition devices. An upper stove, which is mounted at a top side of the lower stove, has a second stove member and an infrared rays burner at a side of the second stove member associated with the gas burner and connected to one of the gas ignition devices, and a first ignition device is mounted at an end of the infrared rays burner and connected to one of the gas ignition devices, which has a gas tube and an ignition member associated with the infrared rays burner. The first ignition device ignites the gas issued to the infrared rays burner prior to the gas ignition device.

### BACKGROUND OF THE INVENTION

1. Field of the Invention

The present invention relates generally to a gas stove, and more particularly to a gas stove having double heating devices.

2. Description of the Related Art

Conventional multi-layer gas stove has many models. A conventional double layers gas stove has a lower stove and an upper stove above the lower stove. The lower stove has a casing, a gas burner on the casing and controllers at a front side of the casing. The upper stove has a casing and an infrared rays burner at a side of the casing associated with the lower stove. The gas burner and the infrared rays burner are connected to the controllers via hoses for manipulation of turn on/off the burners. The gas burner of the lower stove heats foods directly, and the infrared rays burner worked with the gas burner of the lower stove to bake chickens and meats.

The infrared rays burner has a heating member and an ignition system, wherein the heating member has a casing with a hole at a side thereof and a plurality of ceramics plates on the side of the casing and covering the hole, and the ignition system is mounted on the casing of the heating member to issue gas in the casing and burn it, such that the ceramics plates are heated to provide infrared rays. It is dangerous that the casing is filled with gas prior to ignition. Sometime it gets explosion.

### SUMMARY OF THE INVENTION

The primary objective of the present invention is to provide a gas stove, which has less risk of explosion.

According to the objective of the present invention, a gas stove comprises a lower stove having a first stove member, a plurality of gas ignition devices at a side of the first stove member and a gas burner at a top side of the first stove member and connected to one of the gas ignition devices. An upper stove, which is mounted at a top side of the lower stove, has a second stove member and an infrared rays burner at a side of the second stove member associated with the gas burner and connected to one of the gas ignition devices, and a first ignition device is mounted at an end of the infrared rays burner and connected to one of the gas ignition devices, which has a gas tube and an ignition member associated with the infrared rays burner. Gas issued to the infrared rays burner is ignited by the first ignition device first.

### BRIEF DESCRIPTION OF THE DRAWINGS

FIG. 1 is a perspective view of a first preferred embodiment of the present invention;

FIG. 2 is a top view of a part of the first preferred embodiment of the present invention, showing the relationship of the infrared rays burner and the first ignition device, and

FIG. 3 is a top view of a part of the first preferred embodiment of the present invention, showing the relationship of the infrared rays burner and the first ignition device.

### DETAILED DESCRIPTION OF THE INVENTION

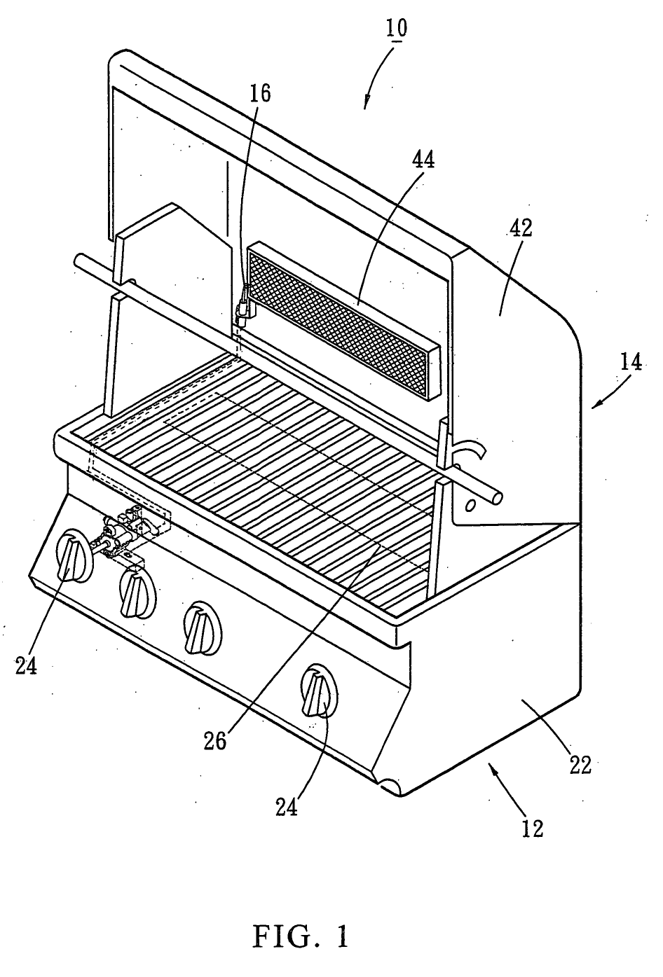

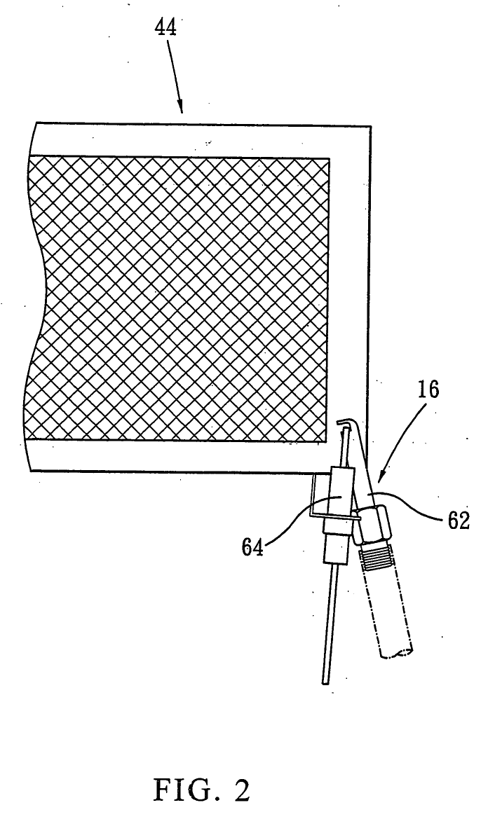

As shown in FIG. 1 and FIG. 2, a gas stove 10 of the first preferred embodiment of the present invention mainly comprises a lower stove 12 and an upper stove 14. The lower stove 12 has a first stove member 22, a plurality of ignition devices 24 at a front side of the first stove member 22 and a gas burner 26 in the first stove member 22 and connected to the gas ignition device 24. The upper stove 14, which is mounted at a top side of the lower stove 12, has a second stove member 42 and an infrared rays burner 44 at a front side of the second stove member 42 and connected to the gas ignition device 24. The gas ignition device 24 has a plurality of conventional elements, including a gas manifold, a switch, an electronic ignition device and a relay etc. The work of the gas burner 26 and the infrared rays burner 44 are as same as the conventional devices.

A first ignition device 16 is mounted at an end of the infrared rays burner 44, which has a gas tube 62 and an ignition member 64. The gas tube 62 is connected to the gas manifold of the gas ignition device 24 to issue the gas. The ignition member is connected to the electronic ignition device to ignite the gas ejected out of the gas tube 24.

To ignite the upper stove 14 of the gas stove 10 of the present invention, the gas ignition device 24 is activated to issue less gas to the first ignition device 16 for burn, and then the gas issued to the infrared rays burner 44 is ignited by the flame of the first ignition device 16 to heat the ceramics plates.

The gas stove 10 of the present invention provides the first ignition device 16 to the infrared rays burner 44 of the upper stove 14, and the first ignition device 16 is ignited prior to the gas ignition device 24, such that the gas issued to the infrared rays burner 44 is ignited by the first ignition device 16 at once, in other words, only less gas in the infrared rays burner 44 is ignited that reduce the risk of explosion of the conventional gas stove.

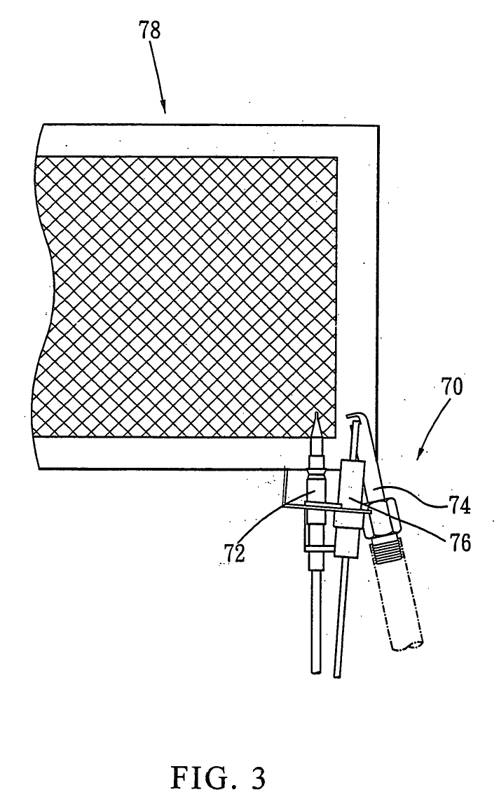

FIG. 3 shows a gas stove of the second preferred embodiment of the present invention, which is similar to the gas stove 10 of the first preferred embodiment, except that a first ignition device 70 of the second preferred embodiment is further provided with an electric heater 72, and the electric heater 72 is connected to the relay of the gas ignition device 24. While gas is ejected from a gas tube 74 and ignited by an ignition member 76, the electric heater 72 is heated and has a potential difference to issue the gas to an infrared rays burner 44 continuously for burn.

In conclusion, the present invention provides the first ignition device to the infrared rays burner, and the first ignition device is ignited prior to the gas ignition device, such that the gas issued to the infrared rays burner is ignited by the first ignition device at once and there is less risk of explosion.

What is claimed is:

1. A gas stove, comprising:
a lower stove having a first stove member, a plurality of gas ignition devices at a side of the first stove member and a gas burner at a top side of the first stove member and connected to one of the gas ignition devices;
an upper stove, which is mounted at a top side of the lower stove, having a second stove member and an infrared rays burner at a side of the second stove member associated with the gas burner and connected to one of the gas ignition devices, and
a first ignition device mounted at an end of the infrared rays burner and connected to one of the gas ignition devices, which has a gas tube and an ignition member associated with the infrared rays burner; wherein gas issued to the infrared rays burner is ignited by the first ignition device first.

2. The gas stove as defined in claim 1, wherein the gas tube is connected to a gas manifold of the gas ignition device.

3. The gas stove as defined in claim 1, wherein the ignition member is connected to an electronic ignition device of the gas ignition device.

4. The gas stove as defined in claim 1, further comprising an electric heater connected to a relay of the gas ignition device.
